(19) United States
(12) Patent Application Publication
(10) Pub. No.: US 2014/0043817 A1
(43) Pub. Date: Feb. 13, 2014

(54) Method And Device For Constructing High-Power LED Lighting Fixture

(71) Applicants: Jiqiang Zhang, Guizhou (CN); Zheyuan Zhang, Guizhou (CN)

(72) Inventors: Jiqiang Zhang, Guizhou (CN); Zheyuan Zhang, Guizhou (CN)

(73) Assignee: GUIZHOU GUANGPUSEN PHOTOELECTRIC CO., LTD., Guizhou (CN)

(21) Appl. No.: 13/980,739

(22) PCT Filed: Jan. 17, 2012
(86) PCT No.: PCT/CN2012/070447

§ 371 Date: Oct. 9, 2013

(30) Foreign Application Priority Data
Jan. 21, 2011 (CN) 201110024636.6
Jan. 21, 2011 (CN) 201120021078.3

(51) Int. Cl. F21K 99/00; F21S 2/00

(52) U.S. Cl. CPC F21K 9/00; F21K 9/90; F21S 2/005; F21K 9/30
USPC 362/249.02; 29/825; 362/368; 362/373; 362/375

(57) ABSTRACT

A method and a device for constructing a high-power LED lighting fixture are disclosed, wherein a high power LED lighting fixture is constructed by assembling one or more standard-interface LED lamp heads, in which an LED optical module and a separate power source are integrated, onto a lamp base (15). This method can have the production process of the LED lighting fixture shortened, and improve its mass productivity.

### TECHNICAL FIELD

The present invention relates to a method and a device for constructing a high-power LED lighting fixture, and belongs to the technical field of LED lighting.

### BACKGROUND

The light emitting diode (LED) has such advantages as the high luminous efficiency, and easy control of the illuminating direction and the luminance. Since the luminous efficiency of most present LED lighting lamps exceeds 70 LM/W, it has an energy-saving advantage over the conventional energy-saving lamp. Theoretically, the luminous efficiency of a green light emitting diode may be up to 683 LM/W, and the theoretical luminous efficiency of a white light emitting diode may be up to 182.45 LM/W, thus the luminous efficiency of LED could be increased greatly.

In the design of the current high-power LED lighting fixture, especially in that of the high-power LED lamp such as a street lamp etc., when assembling a high-power LED lighting fixture, an LED optical module, a power source and a lamp casing should be designed to be assembled together, which means that the LED optical module, the driving power source and the lamp casing must be produced so as to be compatible with each other. This causes a series of vital problems such as high production costs, inconvenient use, difficult maintenance, and so on, to the LED lighting fixture. First, it is impossible to achieve uniform standardized production throughout the country or even the world, which results in too many sizes of products and expensive costs. Second, an LED lighting fixture user may relate to products of several or even tens of producers, since the products are not be interchangeable with each other. Third, the LED optical module, the power source and the lamp casing should be removed wholly during repairing, which may easily cause other failures, extended maintenance time and high maintenance costs. The wide use of the high-power LED is extremely limited by these disadvantages.

### SUMMARY

The present invention aims at providing a method and a device for constructing a high-power LED lighting fixture. It may have the production process of an LED lighting fixture shortened significantly, improves the mass productivity and benefits the industrialization of LED energy-saving lighting products.

As a technical solution of the present invention, a method for constructing a high-power LED lighting fixture is provided, and is characterized in that the high-power LED lighting fixture can be formed by assembling one or more standard-interface (interface of predetermined dimension) LED lamp heads (or lamp bulbs), in which an LED optical module and an independent driving power source are integrated, onto a lamp base.

In the above method for constructing a high-power LED lighting fixture, the heat generated by each of the standard-interface LED lamp heads can be conducted to the lamp base by a connection component of the lamp head and then is dissipated solely by dissipation components of the LED lamp base. The lamp base can be one of various lighting fixtures that could be configured for heat dissipation and be equipped with standard-interface LED lamp heads, such as a street lamp base, a tunnel lamp base, a flood light base, or an indoor-illumination lamp base.

In the above method for constructing a high-power LED lighting fixture, the connection component (standard interface or interface of determined dimension) can comprise a flange connection component, a snap ring connection component, a screw connection component, a bayonet connection component, or a clamp spring connection component.

An standard interface LED lamp head is provided and is characterized in that it can comprise a lamp frame, a lamp bead integration module in which an LED optical module and a separate power source are integrated can be provided in the lamp frame, a superconductive graphite pad can be provided between the lamp frame and the lamp bead integration module, and a through hole can be provided in the lamp frame.

In the above standard-interface LED lamp head, the lamp frame can be provided with a flange and thereby can be fixed to the lamp base through screws, or the lamp frame can be provided with a screw thread, a bayonet or a snap spring and thereby can be connected with a seat fixed on the lamp base so as to generate a heat conduction connection with the lamp base, the seat can comprise a screw seat, a bayonet seat or a snap spring seat, and the superconductive graphite pad can be provided between the respective fixing structures.

In the above standard interface LED lamp head a diameter of a distribution circle of screw holes on the flange or a diameter of a distribution circle of screw holes on the seat may be selected from several predetermined dimensions depending on the power of LED so as to facilitate the standardization of production and maintenance. The distribution circle has the diameter of 60˜80 mm when the power of LED is below 30 W; the distribution circle has the diameter of 80˜100 mm when the power of LED is 30 W˜50 W; the distribution circle has the diameter of 100˜120 mm when the power of LED is 50 W˜100 W.

In the above standard-interface LED lamp head, a lens configurable as a convex lens or a planar lens can be provided and fixed on the lamp frame through an adhesive or a lens cover.

In the above standard interface LED lamp head, the through hole can be connected with a waterproof coupler, a high-temperature gasket can be provided between the lamp frame and the lens, and a cavity for storing a superconducting liquid can be provided within the lamp frame and then can be filled with the superconducting liquid so as to facilitate the conduction of heat.

A standard-interface LED lamp head is provided and is characterized in that it can comprise a lens, a groove can be provided on the lens, a lamp bead integration module in which an LED optical module and a separate power source are integrated can be provided in the groove, the lamp bead integration module can be fixed on the lens through an adhesive, and a through hole can be provided on the lens.

In the above standard-interface LED lamp head, the lens can be fixed on a lamp base via a snap ring through screws; a high-temperature gasket can be provided between the lens and the snap ring as a buffer.

A high-power LED lighting fixture is provided and is characterized in that it can comprise a lamp base on which one or more standard-interface LED lamp heads, in which an LED optical module and a separate power source are integrated, can be provided. A high-power LED lighting fixture is formed by assembling one or more standard interface (interface of predetermined dimension) LED lamp heads, in which an LED optical module and a separate power source are integrated, onto a lamp base.

Here, the above two kinds of standard-interface LED lamp heads may also be used.

In the above high-power LED lighting fixture, the heat generated by each of the standard interface LED lamp heads can be conducted to the lamp base through a connection component of the lamp head and then can be dissipated through dissipation components of the lamp base. The lamp base can be one of various lighting fixtures that could be configured for heat dissipation and be equipped with standard-interface LED lamp heads, such as a street lamp base, a tunnel lamp base, a flood light base, or an indoor-illumination lamp base.

In the above high-power LED lighting fixture, the connection component (i.e. standard interface or interface of predetermined dimension) can comprise a flange connection component, a snap ring connection component, a screw connection component, a bayonet connection component or a clamp spring connection component.

In the above high-power LED lighting fixture, a distribution circle of connecting screw holes of the connection component has a diameter D1 of 60˜120 mm.

In the above high-power LED lighting fixture, the distribution circle of the connecting screw holes of the connection component has the diameter D1 of 72 mm, 90 mm, or 110 mm.

In the above high-power LED lighting fixture, the distribution circle of the connecting screw holes on the connection component has the diameter D1 of 60˜80 mm when the power of LED is below 30 W; the distribution circle of the connecting screw holes on the connection component has the diameter D1 of 80˜100 mm when the power of LED is 30 W˜50 W; the distribution circle of the connecting screw holes on the connection component has the diameter D1 of 100˜120 mm when the power of LED is 50 W˜100 W. The diameter of the distribution circle of the connecting screw holes on the connection component may be selected from several predetermined dimensions depending on the power of LED so as to facilitate the standardization of production and maintenance.

In the above high-power LED lighting fixture, the distribution circle of the connecting screw holes on the connection component has the diameter D1 of 72 mm when the power of LED is below 30 W; the distribution circle of the connecting screw holes on the connection component has the diameter D1 of 90 mm when the power of LED is 30 W˜50 W; the distribution circle of the connecting screw holes on the connection component has the diameter D1 of 110 mm when the power of LED is 50 W˜100 W.

In the above high-power LED lighting fixture, a diameter of a distribution circle of screw holes on the snap ring may be selected from several predetermined dimensions depending on the power of LED so as to facilitate the standardization of production and maintenance. The distribution circle has the diameter of 60˜80 mm when the power of LED is below 30 W; the distribution circle has the diameter of 80˜100 mm when the power of LED is 30 W˜50 W; the distribution circle has the diameter of 100˜120 mm when the power of LED is 50 W˜100 W.

Compared to the prior art, according to the present invention, a high-power LED lighting fixture is constructed by using a standard-interface LED lamp head in which an LED optical module and a separate power source are integrated to cooperate with peripheral components of the lighting fixture so that the standard-interface LED lamp head may be produced separately and the lamp base may be produced separately according to the interface of the lamp head, both of which may be used for constructing different LED lighting fixture as universal components to simplify the design and the production of LED lighting fixtures greatly. According to the heat dissipation design, the heat generated by a light source may be effectively conducted to the lamp base, then the heat is dissipated by the lamp base or dissipated by other dissipating components on the lamp base (heat conduction sheets provided on the lamp base) together, thus the LED lamp head with the standard interface may simplify the heat dissipation design for constructing the high-power LED lighting fixture, i.e. the heat dissipating part needs not to be redesigned when a high-power LED lighting fixture is reconstructed. When constructing a street lamp, it is only required to install the standard-interface LED lamp head according to the present invention onto the lamp base of the street lamp, and when constructing other lighting fixtures, it is only required to install the standard interface LED lamp head according to the present invention onto the lamp base of other lighting fixtures. The waterproof quick-change coupler may be used between the lamp head and the mains supply to facilitate removal. In the maintenance of the high-power standard-interface LED lighting fixture constructed according to the present invention, it is only required to replace or remove the standard-interface lamp head, which is very convenient and may not cause any further failures. The standard-interface lamp head according to the present invention may use various standard connections such as a flange connection, a screw thread connection, a bayonet connection, a clamp spring connection, and the like. In order to achieve the universal interface and the interchangeability, the diameter of the distribution circle of screw holes on the connection component in the standard-interface LED lamp head may be selected from several predetermined dimensions depending on the power of LED. Generally, the distribution circle has the diameter D1=60˜80 mm for an illumination case in which the power is below 30 W; the distribution circle has the diameter D1=80˜100 mm an illumination case in which the power is 30˜50 W; the distribution circle has the diameter D1=100˜120 mm for an illumination case in which the power is 50˜100 W. This may not only effectively reduce the production costs, but also significantly facilitate the installation and the maintenance, so that the present invention may be applied to various fields.

The present invention can also be used for reconstructing the conventional high-power LED lighting fixture. The LED optical module may be installed in the standard-interface lamp head and the LED power source may be formed as a separate waterproof structure and connected with the lamp head by a waterproof quick-change coupler to facilitate the production and use thereof.

Therefore, the present invention may standardize a lighting source of the high-power standard-interface LED lighting fixture so as to facilitate standardizing the production, and may reduce the production costs and the design costs. Further, the lighting source of the high-power LED lighting fixture with the standard interface is of high commonality and is convenient to maintain so as to promote the popularization of the high-power LED lighting fixture.

### BRIEF DESCRIPTION OF THE DRAWING

FIG. 1 is a schematic view illustrating the structure of a lamp head in a flange connection according to Example 1 of the present invention;

FIGS. 2 and 3 are schematic views illustrating the structure of a lamp head in a bayonet connection according to Example 1 of the present invention, respectively;

FIG. 4 is a schematic view illustrating the structure of a lamp head in a screw thread connection according to Example 2 of the present invention;

FIG. 5 is a schematic view illustrating structure of a lamp head in a screw thread connection according to Example 3 of the present invention;

FIG. 6 is a schematic view illustrating the structure of a lamp head in a snap-ring connection according to Example 4 of the present invention;

FIG. 7 is a schematic view illustrating the structure of a street lamp according to an example of the present invention; and

FIG. 8 is a schematic view illustrating the structure of a flood lamp according to an example of the present invention.

### LIST OF REFERENCE NUMERALS IN THE DRAWINGS

1—Superconductive Graphite Pad
2—Seat
3—Inlet Hole for Superconducting Liquid
4—Superconducting Liquid
5—Lamp Frame
6—Lamp Bead Integration Module
7—High-temperature Gasket
8—Lens Cover
9—Lens
10—Through Hole
11—Waterproof Coupler
12—Snap Ring
13—Bayonet Ring
14—Screw
15—Lamp base

### DETAILED DESCRIPTION

Hereinafter, the present invention will be further explained with reference to the drawings in connection with examples, which, however, should not be interpreted as limitations to the present invention.

### EXAMPLES

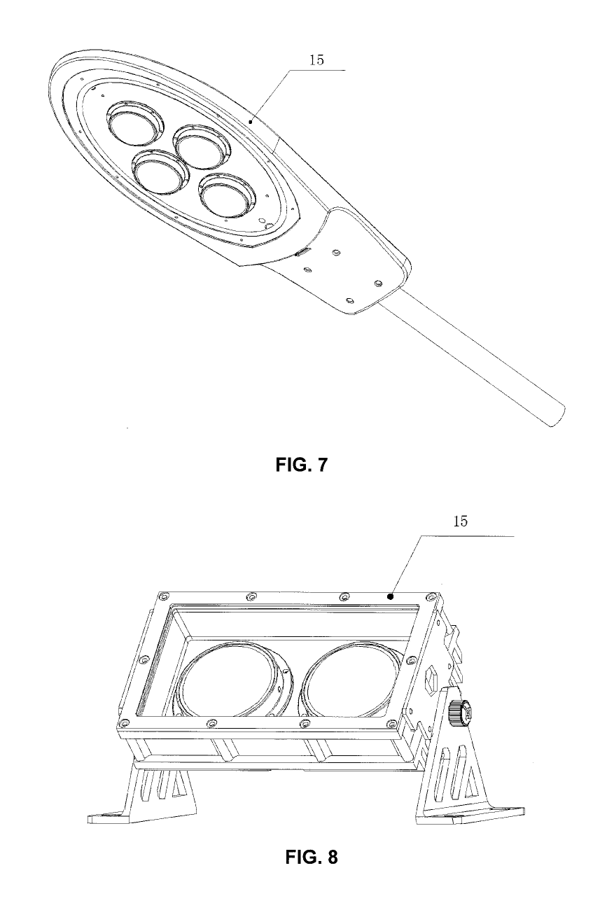

In a method for constructing a high-power LED lighting fixture, the high-power LED lighting fixture can be constructed by assembling one or more standard-interface LED lamp heads, in which an LED optical module and a separate power source are integrated, onto a lamp base. The heat generated by each of the standard-interface LED lamp heads can be conducted to the lamp base through a connection component of the lamp head and then can be dissipated solely by dissipation components of the lamp base. Said connection component can comprise a flange connection component, a snap-ring connection component, a screw thread connection component, a bayonet connection component, or a clamp spring connection component. Said lamp base can be one of various lighting fixtures that could be configured for heat dissipation and be equipped with standard-interface LED lamp heads, such as a street lamp base, a tunnel lamp base, a flood light base, or an indoor-illumination lamp base. A lighting fixture in the form of street lamp is illustrated in FIG. 7, and a lighting fixture in the form of flood light is illustrated in FIG. 8.

### Example 1

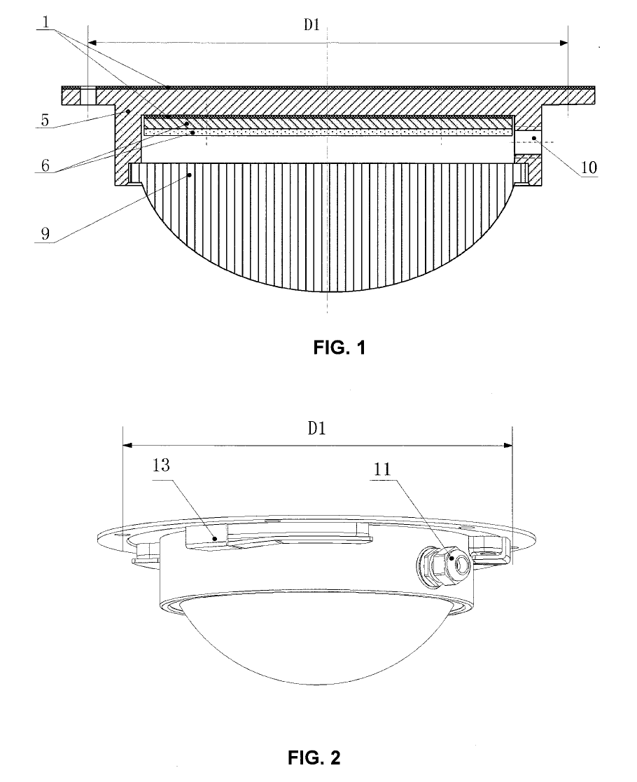

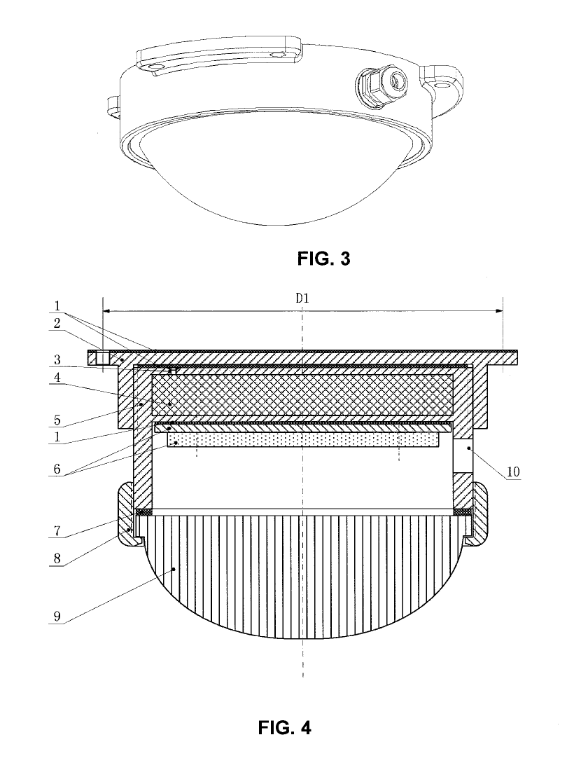

With reference to FIG. 1, a standard-interface LED lamp head can comprise a lamp frame 5. A lamp bead integration module 6 in which an LED optical module and a separate power source are integrated can be provided in the lamp frame 5. A superconductive graphite pad 1 can provided between the lamp frame 5 and the lamp bead integration module 6, and a through hole 10 is provided in the lamp frame 5. The lamp frame 5 can be provided with a flange and thereby can be fixed to the lamp base through screws. A diameter D1 of a distribution circle of screw holes on the flange or a diameter D1 of a distribution circle of screw holes on the seat 2 may be selected from several predetermined dimensions depending on the power of LED so as to facilitate the standardization of production and maintenance. Alternatively, the lamp frame 5 can be provided with a screw thread, a bayonet, or a snap spring and thereby can be connected with the seat 2 fixed on the lamp base so as to generate a heat conduction connection with the lamp base, and the seat 2 can be configured as a screw seat, a bayonet seat or a snap spring seat. A superconductive graphite pad 1 is provided between the respective fixing structures. In use, for an illumination case in which the power is below 30 W, the distribution circle has the diameter D1=72 mm; for an illumination case in which the power is 30˜50 W, the distribution circle has the diameter D1=90 mm; for an illumination case in which the power is 50˜100 W, the distribution circle has the diameter D1=110 mm. The above three dimensions can substantially meet various requirements, and thus a producer or user only needs to produce or buy a lamp head or a lighting fixture according to the required dimension. For example, a standard-interface LED lamp head having the diameter D1=90 mm can be installed not only on street lamps of various shapes, but also on different flood lamps or other lighting fixtures of various shapes, as long as the lighting fixture has a surface with a diameter of 100 mm (D1+width of edge) by which a standard-interface LED lamp head can be installed and the heat dissipation can be enabled. As shown in FIGS. 2 and 3, a bayonet ring 13 can be configured as a bayonet connection for connectors. A lens 9 configurable as a convex lens or a planar lens can be provided and fixed on the lamp frame 5 through an adhesive or a lens cover 8. The through hole 10 can be connected with a waterproof coupler 11.

### Example 2

With reference to FIG. 2, a standard-interface LED lamp head (standard high-power outdoor LED lamp head with screw thread connection) can comprise a lamp frame 5. A lamp bead integration module 6 (in which an LED optical module and an independent driving power source are integrated) can be provided in the lamp base 5. A superconductive graphite pad 1 can be provided between the lamp frame 5 and the lamp bead integration module 6, and a through hole 10 for threading wires can be provided in the lamp frame 5. A waterproof coupler 11 is provided at the through hole 10. The lamp frame 5 is fixed onto the lamp base 2 though a lamp head screw thread of the national standard E27, and a superconductive graphite pad 1 can be provided between the lamp frame 5 and the lamp base 2. A superconducting liquid 4 can also be provided in the lamp frame 5. A lens 9 (convex lens) can be provided on the lamp frame 5. The lens 9 (convex lens) can be connected with the lamp frame 5 through a lens cover 8 (provided with a screw thread). A high-temperature gasket 7 can also be provided between the lens 9 and the lamp frame 5.

### Example 3

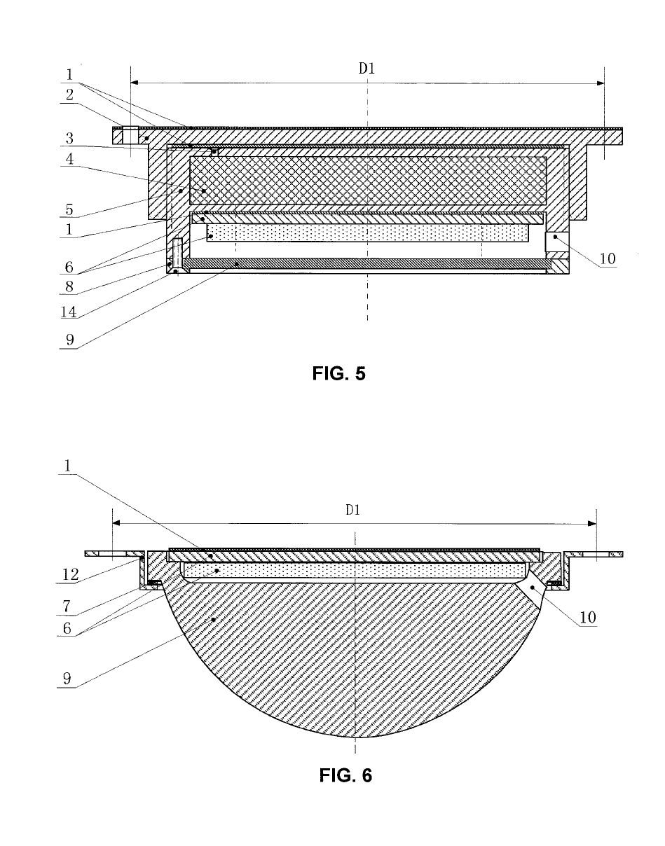

With reference to FIG. 5, a standard-interface LED lamp head (standard high-power outdoor LED lamp head with screw thread connection) can comprise a lamp frame 5. A lamp bead integration module 6 in which an LED optical module and an independent driving power source are integrated can be provided in the lamp frame 5. A superconductive graphite pad 1 can be provided between the lamp frame 5 and the lamp bead integration module 6, and a through hole 10 for threading wires can be provided in the lamp frame 5. A waterproof coupler can be provided at the through hole 10. The lamp frame 5 can be provided with a international standard screw thread and thereby can be fixed onto the lamp base 2. A superconductive graphite pad 1 is arranged between the lamp frame 5 and the lamp base 2. A superconducting liquid 4 can also be provided in the lamp frame 5. A lens 9 (planar lens) can be provided on the lamp frame 5. The lens 9 (planar lens) can be connected with lamp frame 5 through a lens cover 8. The lens cover 8 can be provided with a screw 14 and thereby can be fixed onto the lamp frame 5.

### Example 4

With reference to FIG. 6, a standard-interface LED lamp head can comprise a lens 9 provided with a groove. A lamp bead integration module 6 in which an LED optical module and a separate power source are integrated can be provided in the groove. The lamp bead integration module 6 can be fixed on the lens 9 through an adhesive. A through hole 10 can be provided in the lens 9. A diameter D1 of a distribution circle of screw holes on a snap ring 12 may be selected from several predetermined dimensions depending on the power of LED so as to facilitate the standardization of production and maintenance. The lens 9 can be fixed on a lamp base via the snap ring 12 through screws; and a high-temperature gasket 7 can be provided between the lens 9 and the snap ring 12 as a buffer. In use, for an illumination case in which the power is below 30 W, the distribution circle has the diameter D1=72 mm; for an illumination case in which the power is 30˜50 W, the distribution circle has the diameter D1=90 mm; for an illumination case in which the power is 50˜100 W, the distribution circle has the diameter D1=110 mm. The above three dimensions can substantially meet various requirements, and thus a producer or user only needs to produce or buy a lamp head or a lighting fixture according to the required dimension. For example, a standard-interface LED lamp head having the diameter D1=90 mm can be installed not only on street lamps of various shapes, but also on different flood lamps or other lighting fixtures of various shapes, as long as the lighting fixture has a surface with a diameter of 100 mm (D1+width of edge) by which a standard-interface LED lamp head can be installed and the heat dissipation can be enabled.

A high-power LED lighting fixture can comprise a lamp base 15. One or more standard-interface LED lamp heads, in which an LED optical module and a separated power source are integrated, can be provided on the lamp base 15. The lamp base 15 can be connected with the LED lamp head through a connection component which can comprise a flange connection component, a snap ring connection component, a screw thread connection component, a bayonet connection component, or a clamp spring connection component. The lamp base 15 can comprise a street lamp base, a tunnel lamp base, a flood light base, or an indoor-illumination lamp base. On the connection component, the distribution circle has the diameter D1 as follows: for an illumination case in which the power is below 30 W, D1=60˜80 mm; for an illumination case in which the power is 30˜50 W, D1=80˜100 mm; for an illumination case in which the power is 50˜100 W, D1=100˜120 mm. A lighting fixture in the form of a street lamp is illustrated in FIG. 7, and a lighting fixture in the form of a flood light is illustrated in FIG. 8.

What is claimed is:

1. A method for constructing a high-power LED lighting fixture characterized in that the high-power LED lighting fixture is formed by assembling one or more LED standard-interface lamp heads, in which an LED optical module and a separate power source are integrated, onto a lamp base, the heat generated by each of the standard-interface LED lamp heads being conducted to the lamp base through a connection component of the lamp head and then being dissipated solely by dissipation components of the lamp base.

2. The method of claim 1 characterized in that the connection component comprises a flange connection component, a snap-ring connection component, a screw thread connection component, a bayonet connection component, or a clamp spring connection component.

3. A standard-interface LED lamp head characterized in that it comprises a lamp frame (5), a lamp bead integration module (6) in which an LED optical module and a separate power source are integrated is provided in the lamp frame (5), a superconductive graphite pad (1) is provided between the lamp frame (5) and the lamp bead integration module (6), and a through hole (10) is provided in the lamp frame (5).

4. The standard-interface LED lamp head of claim 3 characterized in that the lamp frame (5) is provided with a flange and thereby is fixed to the lamp base through screws, or
the lamp frame (5) is provided with a screw thread, a bayonet, or a snap spring and thereby is connected with a seat (2) fixed on the lamp base so as to generate a heat conduction connection with the lamp base, the seat (2) is configured as a screw thread seat, a bayonet seat, or a snap spring seat, and the superconductive graphite pad (1) is provided between the respective fixing structures.

5. The standard-interface LED lamp head of claim 4 characterized in that a diameter D1 of a distribution circle of screw holes on the flange (5) or a diameter D 1 of a distribution circle of screw holes on the seat (2) is selected from several predetermined dimensions depending on the power of LED so as to facilitate the standardization of production and maintenance.

6. The standard-interface LED lamp of claim 3, 4, or 5 characterized in that a lens (9) configurable as a convex lens or a planar lens is provided and fixed on the lamp frame (5) through an adhesive or a lens cover (8).

7. The standard-interface LED lamp of claim 6 characterized in that the through hole (10) is connected with a waterproof coupler (11), a high-temperature gasket (7) is provided between the lamp frame (5) and the lens (9), and a cavity for storing a superconducting liquid (4) is provided within the lamp frame (5).

8. A standard-interface LED lamp head characterized in that it comprises a lens (9), a groove is provided on the lens (9), a lamp bead integration module (6) in which an LED optical module and a separate power source are integrated is provided in the groove, the lamp bead integration module (6) is fixed on the lens (9) through an adhesive, and a through hole (10) is provided in the lens (9).

9. The standard-interface LED lamp head of claim 8 characterized in that the lens (9) is fixed on a lamp base via a snap ring (12) by screws, and a high-temperature gasket (7) is provided between the lens (9) and the snap ring (12) as a buffer.

10. The standard-interface LED lamp head of claim 8 or 9 characterized in that a diameter D1 of a distribution circle of screw holes on the snap ring (12) may be selected from several predetermined dimensions depending on the power of LED so as to facilitate the standardization of production and maintenance.

11. A high-power LED lighting fixture characterized in that it comprises a lamp base (15), and one or more standard-interface LED lamp heads, in which an LED optical module and a separate power source are integrated, are provided on the lamp base (15).

12. The high-power LED lighting fixture of claim 11 characterized in that a connection component between the lamp base (15) and the standard-interface LED lamp head comprises a flange connection component, a snap ring connection component, a screw thread connection component, a bayonet connection component, or a clamp spring connection component.

13. The high-power LED lighting fixture of claim 11 or 12 characterized in that the lamp base (15) comprises a street lamp base, a tunnel lamp base, a flood light base, or an indoor-illumination lamp base.

14. The high-power LED lighting fixture of claim 13 characterized in that a distribution circle of connecting screw holes of the connection component has a diameter D1 between 60 and 120 mm.

15. The high-power LED lighting fixture of claim 14 characterized in that the distribution circle of the connecting screw holes of the connection component has the diameter D1 of 72 mm, 90 mm or 110 mm.

16. The high-power LED lighting fixture of claim 14 characterized in that the distribution circle of the connecting screw holes on the connection component has the diameter D1 of 60˜80 mm when the power of LED is below 30 W;
the distribution circle of the connecting screw holes on the connection component has the diameter D1 of 80˜100 mm when the power of LED is 30 W˜50 W;
the distribution circle of the connecting screw holes on the connection component has the diameter D1 of 100˜120 mm when the power of LED is 50 W˜100 W.

17. The high-power LED lighting fixture of claim 15 characterized in that the distribution circle of the connecting screw holes on the connection component has the diameter D1 of 72 mm when the power of LED is below 30 W;
the distribution circle of the connecting screw holes on the connection component has the diameter D1 of 90 mm when the power of LED is 30 W˜50 W;
the distribution circle of the connecting screw holes on the connection component has the diameter D1 of 110 mm when the power of LED is 50 W˜100 W.
